(19) United States
(12) Patent Application Publication
(10) Pub. No.: US 2015/0015792 A1
(43) Pub. Date: Jan. 15, 2015

(54) FILTERING A DISPLACEMENT FIELD BETWEEN VIDEO FRAMES

(71) Applicant: THOMSON LICENSING, Issy de Moulineaux (FR)

(72) Inventors: Philippe Robert, Rennes (FR); Tomas Enrique Crivelli, Rennes (FR); Pierre-Henri Conze, Rennes (FR); Matthieu Fradet, Chanteloup (FR); Patrick Perez, Rennes (FR)

(21) Appl. No.: 14/382,689

(22) PCT Filed: Mar. 1, 2013
(86) PCT No.: PCT/EP2013/054165

§ 371 Date: Sep. 3, 2014

(30) Foreign Application Priority Data
Mar. 5, 2012 (EP) 12305266.4

(51) Int. Cl. H04N 5/14; H04N 7/01

(52) U.S. Cl. CPC H04N 5/145; H04N 7/014
USPC 348/699

(57) ABSTRACT

The invention relates to a method for filtering a displacement field between a first image and a second image, a displacement field comprising for each pixel of the first (reference) image a displacement vector to the second image (current). The method comprises a first step of spatio-temporal filtering wherein a weighted sum of neighboring displacement vectors produces, for each pixel of the first image, a filtered displacement vector. The filtering step is remarkable in that a weight in the weighted sum is a trajectory weight, that is a trajectory weight is representative of a trajectory similarity. According to an advantageous characteristic, a trajectory associated to a pixel of the first image comprises a plurality of displacement vectors from the pixel to a plurality of images. According to another advantageous characteristic, a trajectory weight comprises a distance between a trajectory from the pixel and a trajectory from a neighboring pixel. The method also relates to a graphics processing unit and to computer-readable medium for implementing the weight filtering method.

### TECHNICAL FIELD

The present invention relates generally to the field of dense point matching in a video sequence. More precisely, the invention relates to a method for filtering a displacement fields.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

The problem of point and path tracking is a widely studied and still open issue with implications in a broad area of computer vision and image processing. On one side and among others, applications such as object tracking, structure from motion, motion clustering and segmentation, and scene classification may benefit from a set of point trajectories by analyzing an associated feature space. On the other side, applications related to video processing such as augmented reality, texture insertion, scene interpolation, view synthesis, video inpainting and 2D-to-3D conversion eventually require determining a dense set of trajectories or point correspondences that permit to propagate large amounts of information (color, disparity, depth, position, etc.) across the sequence. Dense instantaneous motion information is well represented by optical flow fields and points can be simply propagated through time by accumulation of the motion vectors, also called displacement vectors. That is why state-of-the-art methods as described by Brox and Malik in “Object segmentation by long term analysis of point trajectories” (Proc. ECCV, 2010) or by Sundaram, Brox and Keutzer in “Dense point trajectories by GPU-accelerated large displacement optical flow” (Proc. ECCV, 2010) have built on top of optical flow, methods for dense point tracking using such accumulation of motion vectors. Finally, such state-of-the art methods produce a motion field either based on a from-the-reference integration, for instance using Euler integration as disclosed by Sundaram, Brox and Keutzer in “Dense point trajectories by GPU-accelerated large displacement optical flow” (Proc. ECCV, 2010)) or a to-the-reference integration as disclosed in an international patent application PCT/EP13/050870 filed on Jan. 17^{th}, 2013 by the applicant.

The technical issue is how to combine both representations in order to efficiently exploit their respective benefits such as a better representation of spatio-temporal features of a point (or pixel) for a from-the-reference displacement field and accuracy of the estimation with to-the-reference displacement field.

The present invention provides such a solution.

### SUMMARY OF INVENTION

The invention is directed to a method for filtering a displacement field between a first image and a second image, a displacement field comprising for each pixel of the first (reference) image a displacement vector to the second (current) image, the method comprising a first step of spatio-temporal filtering wherein a weighted sum of neighboring displacement vectors produces, for each pixel of the first image, a filtered displacement vector. The filtering step is remarkable in that a weight in the weighted sum is a trajectory weight where a trajectory weight is representative of a trajectory similarity. Advantageously, the first filtering step allows taking into account trajectory similarities between neighboring points.

According to an advantageous characteristic, a trajectory associated to a pixel of the first image comprises a plurality of displacement vectors from the pixel to a plurality of images. According to another advantageous characteristic, a trajectory weight comprises a distance between a trajectory from the pixel and a trajectory from a neighboring pixel.

In a first embodiment, the first step of spatio-temporal filtering comprises for each pixel of the first image:
Determining a set of neighboring images around the second image;
Determining a set of neighboring pixels around the pixel of the first image;
Determining neighboring displacement vectors for each neighboring pixel, neighboring displacement vectors belonging to a displacement field between the first image and each image from the set of neighboring images;
Determining a weight for each neighboring displacement vector including a trajectory weight;
Summing weighted neighboring displacement vectors producing a filtered displacement vector.
   According to an advantageous characteristic, the set of neighboring images comprises images temporally placed between the first (reference) image and the second (current) image.
   In a second embodiment, the first spatio-temporal filtering step is applied to a from-the-reference displacement field producing a filtered from-the-reference displacement field; and the method further comprises a second step of joint forward backward spatial filtering comprising a weighted sum of displacement vectors wherein the displacement vector belongs:
   either to a set of filtered from-the-reference displacement vectors between the first image and the second image for each neighboring pixel in the first image;
   or to a set of to-the-reference inverted displacement vectors for each neighboring pixel in the second image of an endpoint location resulting from a from-the-reference displacement vector for the pixel of the first image.

Advantageously in the second filtering step, backward displacement field is used to refine forward displacement field build by a from-the-reference integration. Advantageously the second step is applied on filtered from-the-reference displacement field. In a variant, the second step is applied on from-the-reference displacement field.

In a variant of the second embodiment, the method comprises a second step of joint forward backward spatial filtering comprising a weighted sum of displacement vectors wherein the displacement vector belongs:
either to a set of to-the-reference displacement vectors between the second image and the first image for each neighboring pixel of the second image;
or to a set of filtered from-the-reference inverted displacement vectors for each neighboring pixel in the first image of an endpoint location resulting from a to-the-reference displacement vector for the pixel of the second image.

In another variant of the second embodiment, the method comprises, after the second joint forward backward spatial filtering step, a third step of selecting a displacement vector between a previously filtered displacement vector and a current filtered displacement vector. This variant advantageously produces converging displacement fields.

In a third embodiment, the method comprises, before the first spatio-temporal filtering step a step of occlusion detection wherein a displacement vector for an occluded pixel is discarded in the first and/or second filtering steps.

In a refinement of the third embodiment, the 3 steps (spatio-temporal filtering, joint forward backward filtering, occlusion detection) are sequentially iterated for each displacement vector of successive second images belonging to a video sequence.

In a further refinement of the third embodiment, the steps are iterated for each inconsistent displacement vectors of successive second images belonging to the video sequence. In others words, once displacement vectors are filtered for a set of N images, the filtering is iterated only for inconsistent displacement vectors of the same set of N images. Advantageously, in this refinement, only bad displacement vectors (those for which the similarity of forward and backward displacement vectors are above a threshold) are processed in a second pass.

According to another aspect, the invention is directed to a graphics processing unit comprising means for executing code instructions for performing the method previously described.

According to another aspect, the invention is directed to a computer-readable medium storing computer-executable instructions performing all the steps of the method previously described when executed on a computer.

Any characteristic or variant embodiment described for the method is compatible with the device intended to process the disclosed method or the computer-readable medium.

### BRIEF DESCRIPTION OF DRAWINGS

Preferred features of the present invention will now be described, by way of non-limiting example, with reference to the accompanying drawings, in which:

FIG. 1a illustrates motion integration strategies through Euler integration method according to prior art;

FIG. 1b illustrates motion integration strategies through inverse integration method according to an international patent application of the applicant;

FIG. 2a illustrates estimated trajectories for rotational motion;

FIG. 2b illustrates estimated trajectories for divergent motion;

FIG. 2c illustrates estimated trajectories for zero motion;

FIG. 3a illustrates position square error through time for rotational motion;

FIG. 3b illustrates position square error through time for divergent motion;

FIG. 3c illustrates position square error through time for zero motion;

FIG. 4a illustrates from-the-reference correspondence point scheme;

FIG. 4b illustrates to-the-reference correspondence point scheme;

FIG. 5 illustrates the steps of the method of filtering according to an embodiment of the invention;

FIG. 6 illustrates the steps of the method of filtering according to another embodiment of the invention;

FIG. 7 illustrates a device configured for implementing the method according to an embodiment of the invention; and

FIG. 8 illustrates the neighboring images and pixels for the filtering method.

### DESCRIPTION OF EMBODIMENTS

In the following description, the term “motion vector” or “displacement vector” d_{0,N}(x) comprises a data set which defines a displacement from a pixel x of a first frame I₀ to a corresponding location into a second frame I_{N} of a video sequence and wherein indices 0 and N are numbers representative of the temporal frame position in the video sequence. An elementary motion field defines a motion field between 2 consecutives frames I_{N} and I_{N+1}.

Respectively the terms “motion vector” or “displacement vector”, “elementary motion vector” or “elementary displacement vector”, “motion field” or “displacement field”, “elementary motion field” or “elementary displacement field” are indifferently used in the following description.

A salient idea of the method for filtering a motion field or a set of motion fields for a video sequence is to introduce an information representative of trajectory similarity of spatial and temporal neighboring points in the filtering method.

Consider a sequence of images {Iₙ}_{n:0 . . . N} where Iₙ:G→Λ is defined on the discrete rectangular grid G and A is the color space. Let d_{n,m}:Ω→ [symbol] ² be a displacement field defined on the continuous rectangular square Ω, such that for every xεΩ it corresponds a displacement vector d_{n,m} (x)ε [symbol] ² for the ordered pair of images {Iₙ, Iₘ}. Furthermore, let us call I₀ the reference image. We pose the following problem: Given an input set of elementary optical flow fields v_{n,n+1}:G→ [symbol] ² defined on the grid G, compute the displacement vectors d_{0,m} (x)=d_{0,m} (i,j) ∀m: 1 . . . N, and for the grid position x=(i,j)εG.

This is essentially the problem of determining the position of the initial point (i,j) in I₀ at each subsequent frame, i.e. the trajectory of (i,j) from I₀ to I_{N} or [symbol] _{0:N}(i,j). The classical solution to this problem is to apply a simple Euler's integration method1 which is defined by the iteration

d_{0,m+1}(i,j)=d_{0,m}(i,j)+ν_{m,m+1}((i,j)+d_{0,m}(i,j)) (1)

from which the trajectory position in Iₘ₊₁ is given by xₘ₊₁=(i,j)+d_{0,m+1}(i,j) and ν_{m,m+1}(•) is probably an interpolated value at a non-grid location. Now, is this the best way of computing each displacement vector and hence the trajectory [symbol] _{0:N}(i, j)? In an ideal error-free world, yes. But . . . .

We shall see how the unavoidable optical flow estimation inaccuracies lead to errors in the estimated displacements. Let us call d_{0,m+1} (i,j) the true displacement vector and \hat{d}_{0,m+1} (i,j) an estimation of it. Likewise we use the notation to indicate any estimated error-prone quantity. For a given iteration of (1) we can express the estimation error ξₘ₊₁=\hat{d}_{0,m+1} (i,j)−d_{0,m+1}(i,j) as

$$\begin{matrix}{ξ}_{0 , m + 1} = {\hat{d}}_{0 , m} ( i , j ) - {d}_{0 , m} ( i , j ) + {\hat{v}}_{m , m + 1} ( ( i , j ) + {\hat{d}}_{0 , m} ( i , j ) ) - \\ {v}_{m , m + 1} ( ( i , j ) + {d}_{0 , m} ( i , j ) ) \\ = {ξ}_{0 , m} + {\hat{v}}_{m , m + 1} ( {x}_{m} + {ξ}_{0 , m} ) - {v}_{m , m + 1} ( {x}_{m} ) \\ = {ξ}_{0 , m} + {v}_{m , m + 1} ( {\hat{x}}_{m} ) - {v}_{m , m + 1} ( {x}_{m} ) + {δ}_{m , m + 1} ( {\hat{x}}_{m} )\end{matrix} \qquad ( 2 )$$

with xₘ=(i,j)+d_{0,m} (i,j) and where δ_{m,m+1}(•) accounts for the input optical flow estimation error such that \hat{ν}_{m,m+1}(x)=\hat{ν}_{m,m+1}(x)+δ_{m,m+1}(x). Here we distinguish three types of terms:
An error propagation term ξ_{0,m} which stands for the accumulation of displacement error along the trajectory.
A noise term δ_{m,m+1}(\hat{x}ₘ) which is an error inherent to the estimation of the instantaneous motion maps and is always present.
A motion bias term v_{m,m+1}(\hat{x}ₘ)−v_{m,m+1}(xₘ), which reflects the bias in the current displacement computation given by the fact that the current estimated position is different (by ξ_{0,m}) from the true one.

The two first terms are inherent to the process of integration and elementary motion estimation and thus, they cannot be avoided nor neglected. On the other hand, it is interesting to analyze the motion bias term. We first define the relative motion bias magnitude as

$${B}_{m , m + 1} ( {x}_{m} , {x}_{m} + {ξ}_{0 , m} ) = \frac{‖ {v}_{m , m + 1} ( {x}_{m} + {ξ}_{0 , m} ) - {v}_{m , m + 1} ( {x}_{m} ) ‖}{‖ {v}_{m , m + 1} ( {x}_{m} ) ‖} \leq {sup}_{y ∈ Ω} \frac{‖ {v}_{m , m + 1} ( y ) - {v}_{m , m + 1} ( {x}_{m} ) ‖}{‖ {v}_{m , m + 1} ( {x}_{m} ) ‖} \qquad ( 3 )$$

Note that ∥ξ_{0,m}∥ is in general an increasing value (as the position estimation error inevitably increases along the sequence) and thus this bound cannot be tightened. In other words, as ∥ξ_{0,m}∥ is not bounded, the motion bias term can be arbitrarily large, only limited by the maximum flow difference between two (possibly distant) image points. This undesirable behavior is the cause of the ubiquitous position drift observed in dense optical-flow-based tracking algorithms, independently of the flow estimation precision. What equation (3) states is that even small errors introduced by δ_{m,m+1} may lead to an unbounded drift. How to radically reduce this drift is the concern of what follows.

Surprisingly, we can dramatically reduce the drift effect if we proceed differently while integrating the input optical flow fields. Consider the following iteration for computing d_{n,m}, (i,j)

d_{n,m}(i,j)=ν_{n,n+1}(i,j)+d_{n+1,m}((i,j)+ν_{n,n+1}(i,j)) (4)

for n=m 1, . . . , 0, so that one pass for the index n finally gives the displacement field d_{0,m}. Let us discuss the differences between (1) and (4). Euler's method starts at the reference I₀ and performs the motion accumulation in the sense of motion providing a sequential integration. Meanwhile, what we call inverse integration starts from the target image Iₘ and recursively computes the displacement fields back to the reference image, in a non-causal manner. Note that in (1) a previously estimated displacement value is accumulated with an interpolation of the elementary motion field, which introduces both an error due to the noisy field ν_{m,m+1} itself and an error due to evaluating ν_{m,m+1} at a position biased by the current accumulated drift. In (4), on the other side, an elementary flow vector is accumulated with an interpolation now of a previously estimated displacement value. However, the difference is that in this second case, the drift is limited to that introduced by ν_{n,n÷1}(i,j)

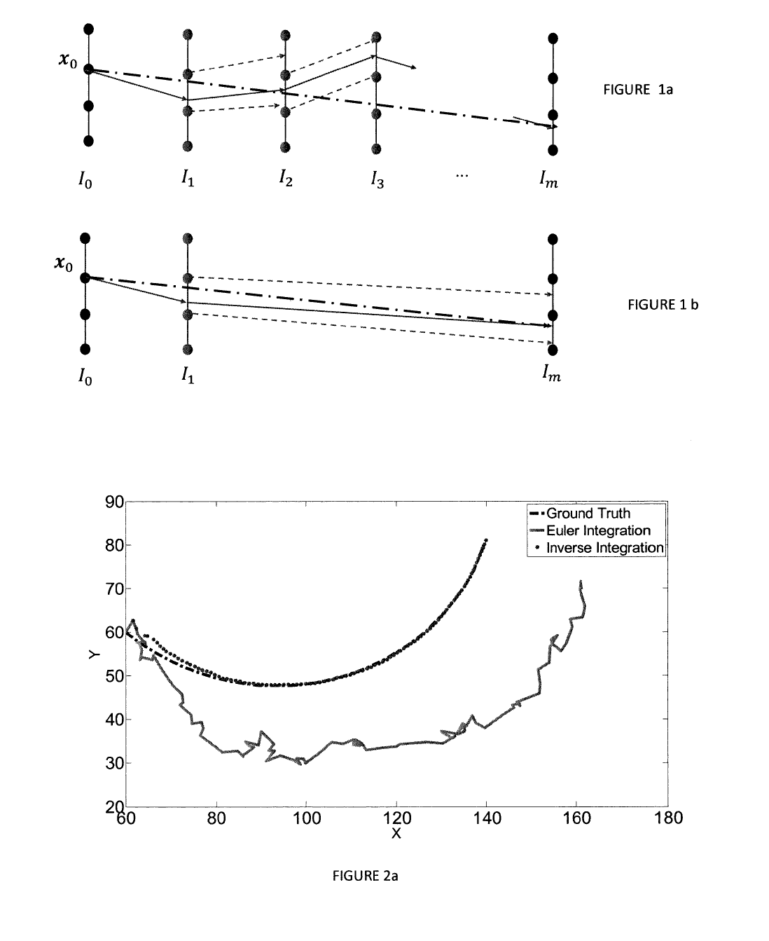

FIG. 1a illustrates motion integration strategies through Euler integration method according to prior art. Euler integration method also called direct integration method performs the estimation by sequentially accumulating the motion vectors in the sense of the sequence, that is to say from the first image I₀ to last image Iₘ.

FIG. 1b illustrates motion integration strategies through inverse integration method according to a method disclosed in an international patent application PCTEP13050870 filed on Jan. 17, 2013 by the applicant. The inverse integration performs the estimation recursively in the opposite sense from the last image to first image.

Effectively, for n=0 we have

ξ_{0,m}=δ_{0,1}(i,j)+d_{1,m}((i,j)+\hat{ν}_{0,1}(i,j))+ε_{1,m}((i,j)+\hat{ν}_{0,1}(i,j))−d_{1,m}((i,j)+\hat{ν}_{0,1}(i,j)) (5)

In this case, as δ_{0,1}(i, j) corresponds to the error term in the estimated optical flow \hat{ν}_{0,1}(i,j), we can assume that ∥δ_{0,1}(i,j)∥ is kept small (it is not an increasing accumulated error as ξ_{0,m} in (3) and thus for the motion bias we have

$${B}_{0 , m} ( {x}_{1} , {x}_{1} + {δ}_{0 , 1} ( i , j ) ) = \frac{‖ {d}_{1 , m} ( {x}_{1} + {δ}_{0 , 1} ( i , j ) ) - {d}_{1 , m} ( {x}_{1} ) ‖}{‖ {d}_{1 , m} ( {x}_{1} ) ‖} \leq {sup}_{y ∈ ρ ( {x}_{1} )} \frac{‖ {d}_{1 , m} ( y ) - {d}_{1 , m} ( {x}_{1} ) ‖}{‖ {d}_{1 , m} ( {x}_{1} ) ‖} \qquad ( 6 )$$

with ρ(x₁) a ball of radius ∥δ_{0,1}(i,j)∥ centered at x₁=(i,j)+ν_{0,1}(i,j). Assuming continuous displacement fields d_{n+1,N} and small elementary motion estimation error ∥δ_{0,1}(i,j)∥, ∥d_{1,m}(y)−d_{1,m}(x₁)∥ is bounded as well as B_{0,m}.

We have attained a highly desirable property, by changing the way of integrating the same input optical flows: the bias introduced at each integration step does not diverge anymore.

We now analyze the behavior of the two integration methods in trajectory estimation, by studying the case of stationary affine motion models perturbed by zero-mean Gaussian noise. We assume elementary motion fields of the form ν_{m,m+1}(x)=Ax+b and the estimated fields are ν_{m,m+1} (x)=d_{m,m+1} (xₘ)+rₘ with rₘ ≡ [symbol] (0, σ²I). The same input fields are used for estimating trajectories using both methods.

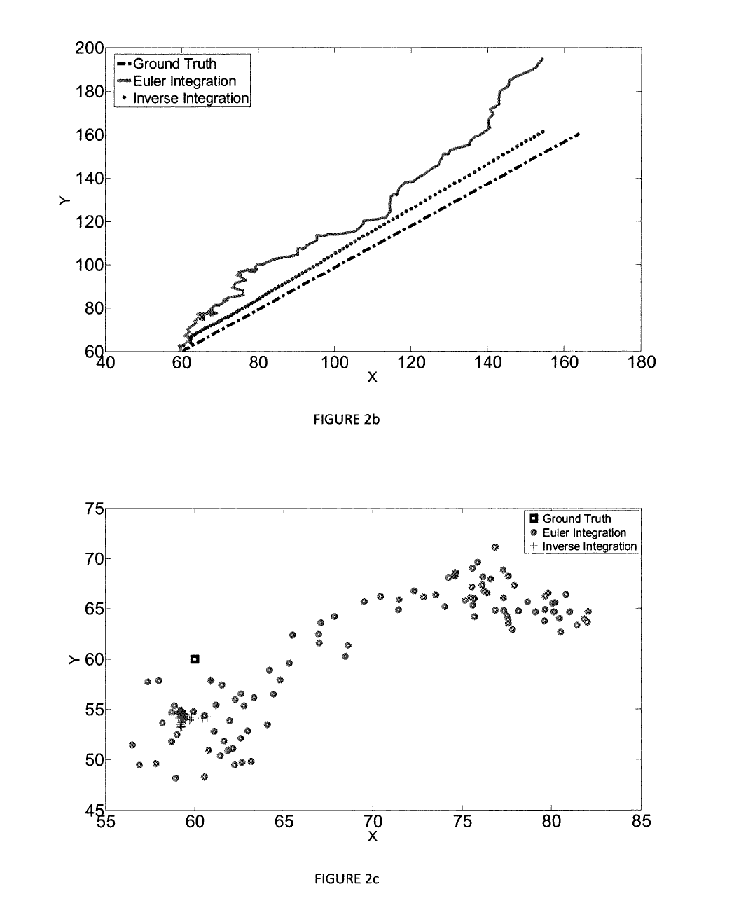

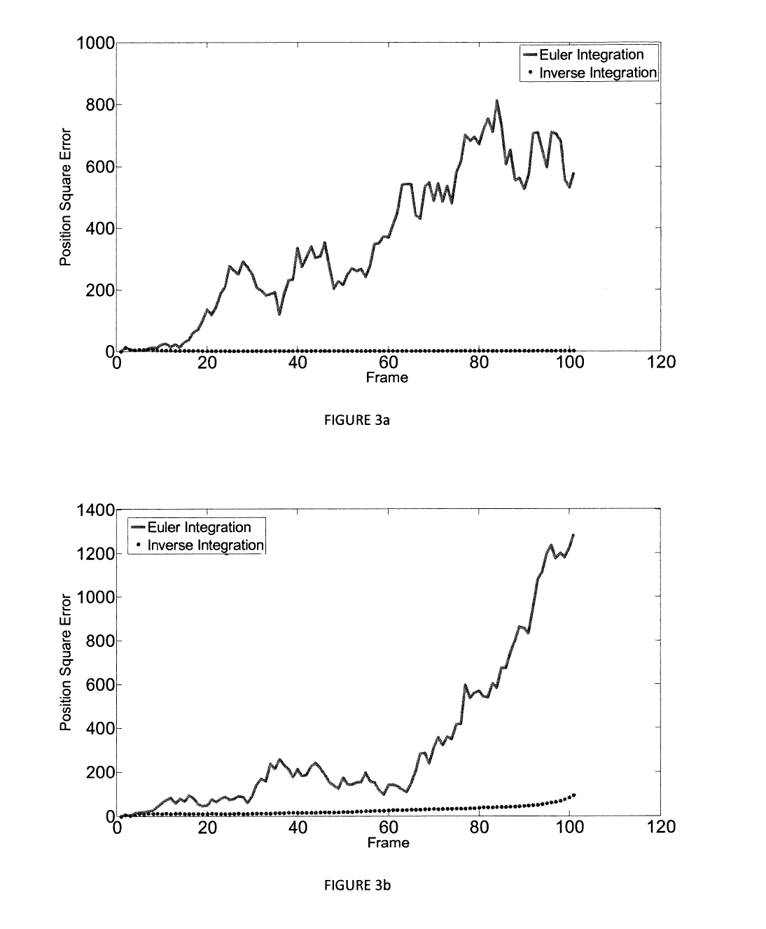

In the case of Euler's integration the application of equation (1) is straightforward, by iterating over m=1 . . . N. For the inverse integration method, equation (4) is repeated for each m: 1 . . . N and n:m−1 . . . 0, so as to obtain the series of displacement fields d_{0,m}. We have tested three different affine models: a rotational motion, a divergent motion and the zero motion. FIGS. 2a, 2b, 2c illustrates estimated trajectories for Euler's method and inverse method for noisy synthetic affine motion fields and FIGS. 3a, 3b, 3c illustrates the results for Euler's method and inverse method. Results show significant improvements in the estimated positions for the inverse method. FIG. 2a illustrates estimated trajectories for rotational motion for Euler's method (blue) and inverse method (green) with respect to ground truth (red). FIG. 2b illustrates estimated trajectories for divergent motion for Euler's method (blue) and inverse method (green) with respect to ground truth (red). FIG. 2c illustrates estimated trajectories for zero motion for Euler's method (blue) and inverse method (green) with respect to ground truth (red). All three different affine models being perturbed by noise of variance σ²=4. FIG. 3a illustrates position square error through time for rotational motion for Euler's method (blue) and inverse method (green). FIG. 3b illustrates position square error through time for divergent motion for Euler's method (blue) and inverse method (green). FIG. 3c illustrates position square error through time for zero motion for Euler's method (blue) and inverse method (green).

The behavior depicted by the simulations can be predicted by analyzing the stability of each integration method by recoursing to the theory of dynamical systems. For simplicity, let us consider ν_{m,m+1} (x)=Ax ∀m:0 . . . N−1. Then the true displacement fields are d_{0,m+1} (x)=((A+I)^{m+1}−I)x and for Euler's method ξ_{0,m+1}(x₀)|_{Euler}=(A+I)·ξ_{0,m}(x₀)|_{Euler}+rₘ while for the inverse integration approach ξ_{0,m+1}(x₀)|_{Inv}=(A+I)^{m}·r₀+ε_{1,m+1} (x₁)|_{Inv}. Essentially, Euler's method error equation is stable if all the eigenvalues λᵢ of A lie inside the unit circle centered at −1 in the complex plane (i.e. |1+λᵢ|<1), and possibly unstable (the error may diverge) otherwise. Meanwhile, the inverse approach defines a linear model with transition matrix equal to the identity and driven by the motion estimation errors rₘ. Though it is not an asymptotically stable system around the zero-error equilibrium point (i.e. ∥ξ_{0,m+1}(x₀)|_{Inv}∥→0 does not hold), it is always stable in the sense of Lyapunov (or just stable, loosely ∥ξ_{0,m+1}(x₀)|_{Inv}∥<ε, for some ε>0, ∀m). The error depends only on the accumulation of instantaneous motion estimation errors, but shows no unstable behavior. Concretely, a divergent field (R(λᵢ)>0), a rotational field (|1+λᵢ|=1) or the zero-field (λᵢ=0→|1+λᵢ|=1) are not well handled by the Euler method. For the case of the inverse method, we must emphasize that our analysis does not imply a zero-error or the absence of error accumulation, but a more robust dynamic behavior. Besides, it also appears that it implicitly performs a temporal filtering of the trajectory as observed in the figures.

Finally, in the general case of an arbitrary motion model, and thanks to the Grobman-Hartman theorem (known from C. Robinson in “Dynamical Systems: Stability, Symbolic Dynamics, and Chaos”, Studies in Advanced Mathematics, CRC Press, 2nd edition 1998) we can study the behavior of both methods by regarding the linear approximations of (1) and (4) around an equilibrium point. This may lead to the problem of analyzing time-varying linear systems, for which it is not trivial to determine its stability properties. However we believe one can still obtain useful and analogous conclusions about the behavior of the error function by applying the theory of time-invariant systems.

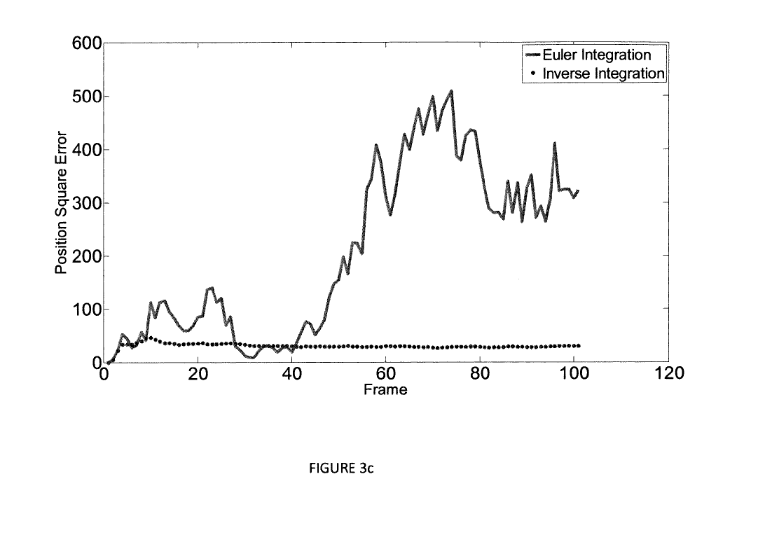

Within the universe of dense point correspondence estimation we have distinguished two different scenarios, tightly bonded together but also to the concrete application one needs to deal with. Let us leave apart for an instant our concern about high accuracy displacement field estimation, and focus on the way we represent the information. Given a reference image, say I₀, we might want to determine either:
From-the-reference correspondences, that is, for all the grid locations of the reference image we seek for their position at each frame of the sequence. This is equivalent to the point tracking problem which is a key component in applications such as object tracking, trajectory clustering, long term object segmentation, activity recognition etc. FIG. 4a illustrates such from-the-reference correspondence point scheme wherein from-the-reference scheme corresponds to the problem of determining the position of each initial grid point in the reference frame, along the sequence, i.e. along the trajectories.
To-the-reference correspondences, that is, for all grid locations of all the frames of the sequence, determine their position in the reference image. We call this the problem of point retrieving. Such representation is more suitable for problems related to propagating information present at a key-frame to the rest of the sequence. For example, graphic elements insertion, video inpainting, user-assisted video editing, disparity propagation, view synthesis, video volume segmentation. In this context, to-the-reference correspondences guarantee that every pixel of every frame is matched with the reference from which one retrieves the desired information. FIG. 4b illustrates to-the-reference correspondence point scheme. To-the-reference corresponds to determining the position in the reference image of each grid point of each image of the sequence.

As illustrated on FIGS. 4a and 4b, each of the mentioned scenarios has a natural representation in terms of displacements fields. Point tracking (from-the-reference) is compactly represented by d_{0,m} (i,j) ∀m: 1 . . . N while for point retrieving (to-the-reference) it is more natural to deal with d_{n,0}, (i,j) ∀n:N . . . 1.

Now returning to the motion integration methods discussed above, one would ask which is the best option, not only in terms of accuracy, but also ease of implementation with regard to the reference (from or to), computational load, memory requirements and of course, concrete application-related issues.

Thus, from-the-reference scheme presents the following characteristics for each integration methods:
Unknown fields: d_{0,m}(i, j) ∀m: 1 . . . N
Ease of implementation: Each iteration of Euler's integration equation naturally generates the trajectory in a sequential manner. Inverse integration needs one whole pass for each m.
Accuracy: Euler low, Inverse high
Computational load: Euler 0(NP), Inverse 0(N²P)
Memory: Euler low, Inverse high

Thus to-the-reference scheme presents the following characteristics for each integration methods:
Unknown fields: d_{n,0}(i, j) ∀n:N . . . 1
Ease of implementation: Inverse method needs only one pass of the process. Euler's method need to initiate a trajectory for each point at each image of the sequence.
Accuracy: Euler low, Inverse high
Computational load: Euler 0(N²P), Inverse 0(NP)
Memory: Euler low, Inverse medium

On the other side, a trajectory-based (from-the-reference) representation of point correspondences seems to be more natural for capturing spatio-temporal features of a point along the sequence as there is a direct (unambiguous) association between points and the path they follow. Consequently, refinement tasks as trajectory based filtering are easier to formulate. Meanwhile, to-the-reference fields do not directly provide such spatio-temporal information but can be efficiently and more accurately estimated. The question is then how to combine both representations which essentially can be formulated as how to pass from one representation to the other in order to efficiently exploit their benefits.

Considering the reference frame I₀ we call forward the from-the-reference displacements fields d_{0,n} and backward the to-the-reference displacement fields d_{n,0}. The set of forward vectors d_{0,n}(x) that give the position of pixel x in the frames n describe its trajectory along the sequence. On the other hand, backward fields d_{n,0}, have been estimated independently and carry consensual, complementary or contradictory information. Forward and backward displacement fields can be advantageously combined in particular to detect inconsistencies and occlusions (this is widely used in stereo vision and for example disclosed by G. Egnal and R. Wildes in “Detecting binocular half-occlusions: empirical comparisons of five approaches”, PAMI, 24(8) 1127-1133, 2002). In addition, one can highlight the interest of combining both approaches in a refinement step as each one can constrain the other. In this section, both forward and backward displacement fields are combined in order to be mutually improved while taking into account the trajectory aspect.

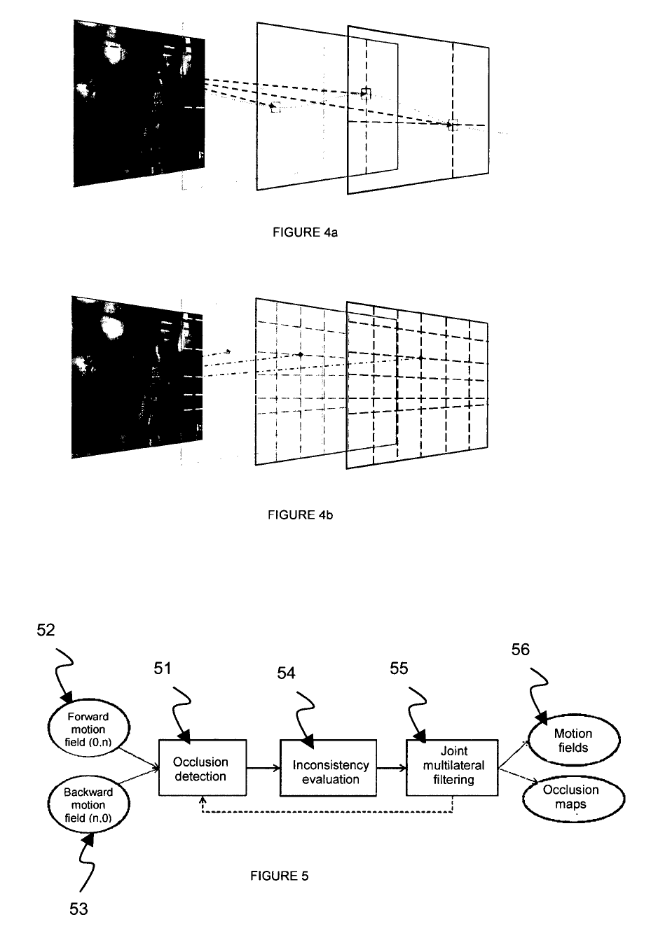

FIG. 5 illustrates the iterative filtering processing according to an embodiment of the invention. The first step 51 is occlusion detection that identifies the vectors of pixels that have no correspondence in the other view. These vectors are then discarded in the filtering process. Inconsistency between forward and backward vector fields is then evaluated in the second step 54. Both forward and backward fields are then jointly updated via a multilateral filtering 55. All the pairs {I₀, Iₙ} are processed similarly. The whole process is iterated up to fields stability.

Occlusions are detected and taken into account in the filtering process. For this sake, the forward 52 (respectively backward 53) displacement field at the reference frame I₀ (respectively, Iₙ) is used to detect occlusions at frame Iₙ (respectively, I₀). The occlusion detection method (called OCC by Egnal) works as follows: addressing the detection of those pixels in frame I₀ that are occluded in frame Iₙ, one considers the displacement map \tilde{d}_{n,0}(x) and scans the image Iₙ, to identify for each pixel via its displacement vector, the corresponding position in frame I₀. Then the closest pixel to this (probably) non-grid position in frame I₀ is marked as visible. At the end of this projection step, the pixels that are not marked in frame I₀ are classified as occluded in frame Iₙ.

Moreover, inconsistency value is evaluated between forward and backward displacement fields on the non-occluded pixels. It provides a way to identify unreliable vectors. After the first process iteration, the filtering is limited to the vectors which inconsistency value is above a threshold.

In the third step 55, for each frame pair {I₀, Iₙ}, forward and backward displacement fields d_{0,n} and d_{n,0} are jointly processed via multilateral filtering. Moreover, the “trajectory” aspect of the forward fields is considered via two ways. First, in addition to generally used weights, a trajectory similarity weight is introduced that replaces classical displacement similarity often introduced when two vectors are compared. Second, 2D filtering is extended to 2D+t along the trajectories.

Each updated vector 56 results from a weighted average of neighboring forward and backward vectors at frame pair {I₀, Iₙ} and also forward vectors d_{0,m} (mε[n−Δ,n+Δ]) at frame pairs {I₀, Iₘ}. Updated forward displacement vector \tilde{d}_{0,n}(x) is obtained as follows:

$${\tilde{d}}_{0 , n} ( x ) = \frac{{\sum }_{m = n - Δ}^{m = n + Δ} {\sum }_{y ∈ {ℱ}_{\{ x \}}} {w}_{traj}^{xy} {w}_{0 , m}^{xy} {d}_{0 , m} ( y ) - {\sum }_{y ∈ {ℱ}_{\{ z \}}} {w}_{n , 0}^{zy} {d}_{n , 0} ( y )}{{\sum }_{m = n - Δ}^{m = n + Δ} {\sum }_{y ∈ {ℱ}_{\{ x \}}} {w}_{traj}^{xy} {w}_{0 , m}^{xy} + {\sum }_{y ∈ {ℱ}_{\{ z \}}} {w}_{n , 0}^{zy}}$$

where [symbol] _{{x}} is a spatial window centered at x and w_{0,m}^{xy} is a weight that links points x and y at frame I₀. Similarly, [symbol] _{{z}} is a spatial window centered at z=x+d_{0,n}(x) and w_{n,0}^{zy} is a weight that links points z and y at frame Iₙ. The weight w_{s,t}^{uv} assigned to each displacement vector d_{s,t}(y) is defined as:

$${w}_{s , t}^{uv} = {ρ}_{st} \times {e}^{- {γ}^{- 1} {Γ}_{uv}^{2} - {ϕ}^{- 1} {Φ}_{uv , s}^{2} - {θ}^{- 1} {Θ}_{v , st}^{2}} \qquad ( 7 )$$

with:
Γᵤᵥ is the Euclidean distance between locations u and v:

Γᵤᵥ=∥u−ν∥₂ (8)

The color similarity Φ_{uv,s} between pixels u and ν in Iₛ is defined as follows:

$${Φ}_{uv , s} = {\sum }_{c ∈ \{ r , g , b \}} \vert {I}_{s}^{c} ( u ) - {I}_{s}^{c} ( v ) \vert$$

The matching cost Θ_{ν,st} is:

Θ_{ν,st}≡Θ_{s,t}(ν,d_{s,t}(ν))=Σ_{cε{r,g,b}}|Iₛ^{c}(ν)−Iₜ^{c}(ν+d_{s,t}(ν))| (9)

ρₛₜ is a binary value that takes into account the occlusion detection as follows:

$${ρ}_{st} = \{ \begin{matrix}0 if pixel y at frame {I}_{s} is occluded in frame {I}_{t} \\ 1 else\end{matrix}$$

The weight

$${w}_{traj}^{xy} = {e}^{- {ψ}^{- 1} {Ψ}_{xy}}$$

refers to the similarity measurement between the trajectories that support the two currently compared forward vectors. This trajectory similarity is defined as follows:

$${Ψ}_{xy} = {\sum }_{m = n - δ}^{m = n + δ} {‖ {d}_{0 , m} ( x ) - {d}_{0 , m} ( y ) ‖}_{2}$$

Similarly, updated backward displacement vector \tilde{d}_{n,0}(x) is obtained as follows:

$${\tilde{d}}_{n , 0} ( x ) = \frac{{\sum }_{y ∈ {ℱ}_{\{ x \}}} {w}_{n , 0}^{xy} {d}_{n , 0} ( y ) - {\sum }_{m = n - Δ}^{m = n + Δ} {\sum }_{y ∈ {ℱ}_{\{ z \}}} {w}_{traj}^{zy} {w}_{0 , m}^{zy} {d}_{0 , m} ( y )}{{\sum }_{y ∈ {ℱ}_{\{ x \}}} {w}_{n , 0}^{xy} + {\sum }_{m = n - Δ}^{m = n + Δ} {\sum }_{y ∈ {ℱ}_{\{ z \}}} {w}_{traj}^{zy} {w}_{0 , m}^{zy}}$$

where [symbol] _{{x}} and [symbol] _{{z}} are windows defined respectively in frames Iₙ around x and I₀ around z=x+d_{n,0} (x).

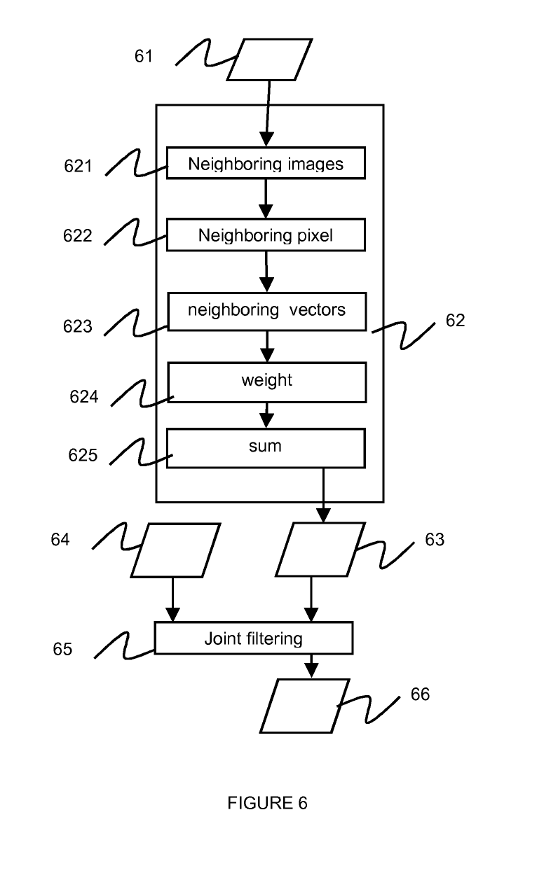

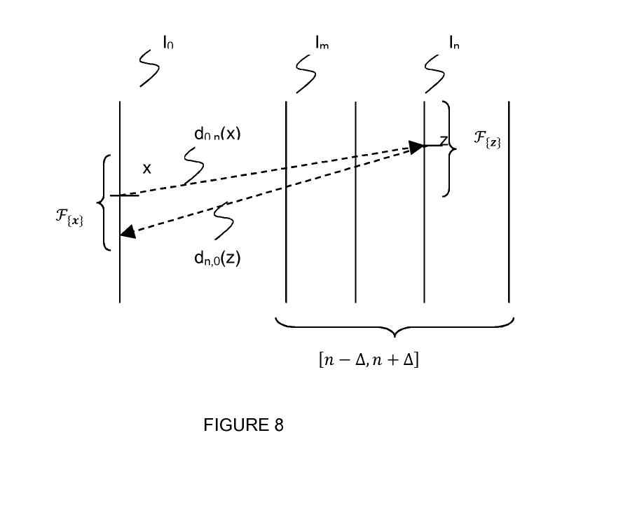

FIG. 6 represents a diagram illustrating the sequential steps of the filtering method according to an embodiment of the invention. An input set 61 of forward or from-the-reference displacement fields is provided at the initialisation of the method. A sequential loop is performed on images of the video sequence. In an advantageous embodiment, displacement field for consecutive images in the video sequence is generated for instance starting from the image I_{I} adjacent to the reference image I₀ and following the order I₀, I₁, . . . to I_{N} for the from-the-reference variant. Thus filtered displacement vectors for intermediary images that are temporally placed between the reference image I₀ and the current image I_{N} are available for the filtering of displacement vectors of the next image I_{N+1}. In a first step 62, filtering (preferentially in parallel) for each pixel X of the reference frame is performed in order to generate a motion field for the whole current image I_{N}. In this first filtering, as previously disclosed, a 2D filtering is extended along the trajectories by introducing temporal filtering. Thus, in a step 621, temporally neighboring images Iₘ (mε[n−Δ, n+Δ]) are determined while in a step 622 spatially neighboring pixel y from pixel x resulting in a spatial window [symbol] _{{x}} centered at x are determined. From this information, neighboring displacement vectors d_{0,m}(y) are determined from temporal and spatial window. FIG. 8 illustrates the neighboring images and pixels for the filtering method. Besides in this first filtering step 62 and as previously disclosed, a trajectory similarity weight wₜᵣₐⱼ^{xy} is introduced that replaces classical displacement similarity often introduced when two vectors are compared. This similarity weight is computed in a step 624 by computing a distance between a trajectory from the pixel x and a trajectory from the neighboring pixel y. Finally in a step 625, the weighted sum of neighboring displacement vectors is performed producing updated forward displacement vector \tilde{d}_{0,n}(x) 63.

In a second filtering step 65, a joint filtering of backward and forward displacement vector is performed. In a first variant, filtered updated forward displacement vectors \tilde{d}_{0,n}(y) 63 and backward displacement vectors d_{n,0}(y) 64 are processed to produce a filtered forward displacement vector \tilde{d}_{0,n}(x) 66. In a second variant, filtered updated forward displacement vectors \tilde{d}_{0,n}(y) 63 and backward displacement vectors d_{n,0}(y) 64 are processed to produce a filtered backward displacement vector \tilde{d}_{n,0}(x) 66. The filtered from-the-reference displacement vectors \tilde{d}_{0,n}(y) 63 are considered for pixels y belonging to the spatial window [symbol] _{{x}} centered at x. While the to-the-reference displacement vectors d_{n,0}(y) 64 are considered for pixels y belonging to the spatial window [symbol] _{{z}} centered at z=x+d_{0,n}(x) that is the endpoint location in the image Iₙ resulting from from-the-reference displacement vector d_{0,n}(x) for pixel x of I₀. FIG. 8 also illustrates the neighboring pixels y of pixel z for the joint backward forward filtering method. This second filtering step 65 produces a filtered motion vector, also noted \tilde{d}_{0,n}(x) (or \tilde{d}_{n,0}(x) for the second variant) 66. In a refinement, the second filtering step 65 generates a filtered from-the-reference displacement field, and in a second pass the second filtering step 65 generates a filtered to-the-reference displacement field 66.

Once the filtering steps 62, 65 are processed, advantageously in parallel, for each pixel of current image, the spatio-temporal filtered motion field 66 is memorized. The filtered motion field is then a motion field available for the filtering of motion field of the next frame to be processed or for a second pass of the algorithm as disclosed in FIG. 5.

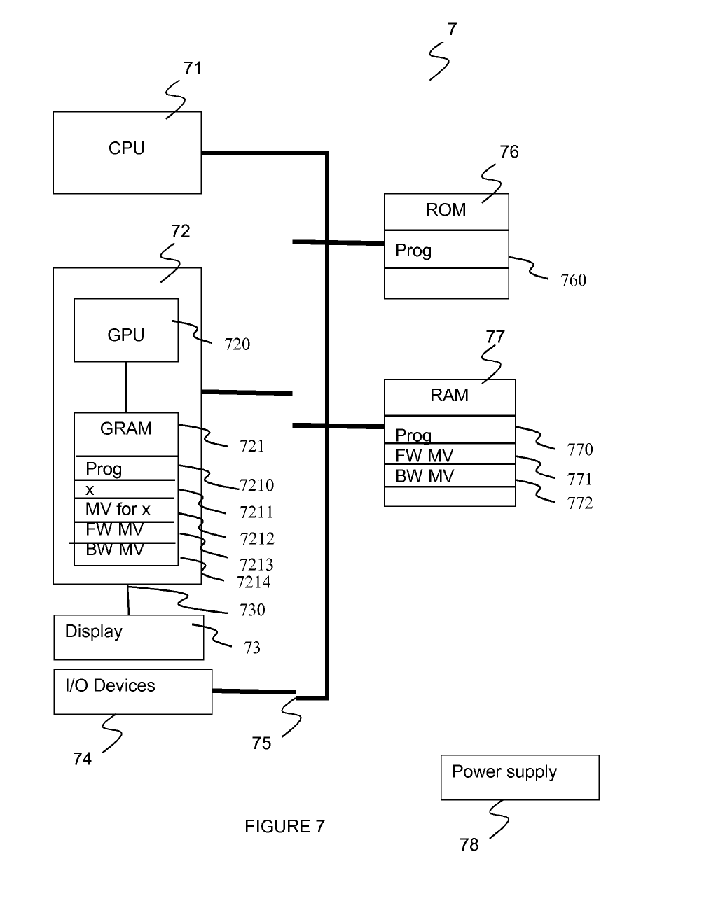

The skilled person will also appreciate that as the method can be implemented quite easily without the need for special equipment by devices such as PCs. According to different variant, features described for the method are being implemented in software module or in hardware module. FIG. 7 illustrates schematically a hardware embodiment of a device 7 adapted for generating motion fields. The device 7 corresponds for example to personal computer, to a laptop, to a game console or to any image processing unit. The device 7 comprises following elements, linked together by an address and data bus 75:
a microprocessor 71 (or CPU);
a graphical card 72 comprising:
   several graphical processing units 720 (GPUs);
   a graphical random access memory 721;
a non volatile memory such as ROM (Read Only Memory) 76;
a RAM (Random Access memory) 77;
one or several Input/Output (IO) devices 74, such as for example a keyboard, a mouse, a webcam, and so on;
a power supply 78.

The device 7 also comprises a display device 73 such as a display screen directly connected to the graphical card 72 for notably displaying the rendering of images computed and composed in the graphical card for example by a video editing tool implementing the filtering according to the invention. According to a variant, the display device 73 is outside the device 7.

It is noted that the word “register” used in the description of memories 72, 76 and 77 designates in each of the memories mentioned, a memory zone of low capacity (some binary data) as well as a memory zone of large capacity (enabling a whole programme to be stored or all or part of the data representative of computed data or data to be displayed).

When powered up, the microprocessor 71 loads and runs the instructions of the algorithm comprised in RAM 77.

The memory RAM 57 comprises in particular:
in a register 770, a “prog” program loaded at power up of the device 7;
data 771 representative of the images of the video sequence and associated displacement fields.

Algorithms implementing the steps of the method of the invention are stored in memory GRAM 721 of the graphical card 72 associated to the device 7 implementing these steps. When powered up and once the data 771 representative of the video sequence have been loaded in RAM 77, GPUs 720 of the graphical card load these data in GRAM 721 and execute instructions of these algorithms under the form of micro-programs called “shaders” using HLSL language (High Level Shader Language), GLSL language (OpenGL Shading Language) for example.

The memory GRAM 721 comprises in particular:
in a register 7210, data representative of spatial window [symbol] _{{x}} centered at x;
displacement vectors for the spatial window [symbol] _{{x}} centered at x for temporal segment [n−Δ, n+Δ] 7211;
the similarity weight 5213 computed for each displacement vectors stored in 7212;
Forward displacement vectors for the spatial window [symbol] _{{x}} centered at x 7213;
Forward and backward displacement vectors for the spatial window [symbol] _{{z}} centered at z 7214.

According to a variant, the power supply is outside the device 7.

The invention as described in the preferred embodiments is advantageously computed using a Graphics processing unit (GPU) on a graphics processing board.

The invention is also therefore implemented preferentially as software code instructions and stored on a computer-readable medium such as a memory (flash, SDRAM . . . ), said instructions being read by a graphics processing unit.

The foregoing description of the embodiments of the invention has been presented for the purposes of illustration and description. It is not intended to be exhaustive or to limit the invention to the precise form disclosed. Persons skilled in the relevant art can appreciate that many modifications and variations are possible in light of the above teaching. It is therefore intended that the scope of the invention is not limited by this detailed description, but rather by the claims appended hereto.

1-11. (canceled)

12. A method for filtering a displacement field between a first image and a second image, said displacement field comprising for each pixel of said first image a displacement vector to the second image, said method comprising a spatio-temporal filtering wherein a weighted sum of neighboring displacement vectors produces, for each pixel of said first image, a filtered displacement vector
and wherein a weight in said weighted sum is a trajectory weight being representative of a trajectory similarity, a trajectory associated to a pixel of said first image comprises a plurality of displacement vectors from said pixel to a plurality of images, said trajectory similarity results from a distance between a trajectory from said pixel and a trajectory from a neighboring pixel.

13. The method for filtering according to claim 11, wherein said spatio-temporal filtering comprises for each pixel of said first image:
Determining a set of neighboring images around said second image;
Determining a set of neighboring pixels around said pixel of said first image;
Determining neighboring displacement vectors for each neighboring pixel, said neighboring displacement vectors belonging to a displacement field between said first image and each image from said set of neighboring images;
Determining a weight for each neighboring displacement vector wherein said trajectory weight comprises a distance between a trajectory from said pixel and a trajectory from said neighboring pixel;
Summing weighted neighboring displacement vectors producing a filtered displacement vector.

14. The method according to claim 13 wherein said determined set of neighboring images comprises images temporally placed between said first image and said second image.

15. The method for filtering according to claim 13 wherein said spatio-temporal filtering is applied to a from-the-reference displacement field producing a filtered from-the-reference displacement field; and further comprising a joint forward backward spatial filtering wherein a weighted sum of displacement vectors produces said filtered displacement vector, said displacement vector belongs:
either to a set of filtered from-the-reference displacement vectors between said first image and said second image for each neighboring pixel of said pixel;
or to a set of to-the-reference inverted displacement vectors for each neighboring pixel in said second image of an endpoint location resulting from a from-the-reference displacement vector for pixel of said first image.

16. The method for filtering according to claim 13 wherein said spatio-temporal filtering is applied to a from-the-reference displacement field producing a filtered from-the-reference displacement field; and further comprising
a joint forward backward spatial filtering wherein a weighted sum of displacement vectors produces said filtered displacement vector said displacement vector belongs:
either to a set of to-the-reference displacement vectors between said second image and said first image for each neighboring pixel of said pixel;
or to a set of filtered from-the-reference inverted displacement vectors for each neighboring pixel in said first image of an endpoint location resulting from a to-the-reference displacement vector for pixel of said second image.

17. The method according to claim 15 further comprising after said joint forward backward spatial filtering:
a selection of a displacement vector between a previously filtered displacement vector and a current filtered displacement vector.

18. The method according to claim 11 further comprising before said spatio-temporal filtering an occlusion detection wherein a displacement vector for an occluded pixel is discarded in the spatio-temporal filtering.

19. The method according to claim 18 wherein spatio-temporal filterings are sequentially iterated for each displacement vector of successive second images belonging to a video sequence.

20. The method according to claim 19 wherein spatio-temporal filterings are further iterated for each inconsistent displacement vectors of successive second images belonging to said video sequence.

21. A device comprising at least one processor and a memory coupled to the at least one processor, wherein the memory stores program instructions, wherein the program instructions are executable by the at least one processor to perform the method of claim 11.

22. A non-transitory program storage device, readable by a computer, tangibly embodying a program of instructions executable by the computer to perform a method of claim 11.
